(19) United States
(12) Patent Application Publication
(10) Pub. No.: US 2007/0209356 A1
(43) Pub. Date: Sep. 13, 2007

(54) Method for providing priority to steering wheel on machines with steering wheel and joystick

(76) Inventors: Joshua D. Graeve, Epworth, IA (US); Eric R. Anderson, Galena, IL (US)

Correspondence Address: BAKER & DANIELS LLP, 300 NORTH MERIDIAN STREET, SUITE 2700, INDIANAPOLIS, IN, 46204, US

(21) Appl. No.: 11/372,592

(22) Filed: Mar. 10, 2006

(51) Int. Cl. F16D 31/02

(52) U.S. Cl. 60/422

(57) ABSTRACT

A vehicle is disclosed having a hydraulic system. The hydraulic system includes first and second user inputs. The hydraulic system in configured to give priority to the first input over the second input.

### BACKGROUND OF THE INVENTION

The present invention relates generally to hydraulic control systems. More particularly, the present invention relates to a hydraulic control system for machines having a steering wheel and a joystick.

### BACKGROUND AND SUMMARY

Many pieces of construction equipment use hydraulics to control the functions performed by the equipment. For example, many pieces of construction equipment use hydraulics to control the steering. On some pieces of construction equipment, both a steering wheel and a joystick are provided to hydraulically control the direction of the vehicle.

According to one exemplary aspect of the present invention, a vehicle is provided that includes a chassis, a plurality of traction devices configured to propel the chassis on the ground, at least one hydraulic actuator positioned to power a function of the vehicle, and a hydraulic control system. The hydraulic control system includes a pressure source providing pressurized hydraulic fluid, a first user input, a valve control assembly that receives pressurized fluid in response to the first user input to control the flow of fluid from the pressure source to the at least one hydraulic actuator, and a second user input. The valve control assembly receives pressurized fluid in response to the second user input to control the flow of fluid from the pressure source to the at least one hydraulic actuator. The hydraulic control system further includes a diverter that communicates the pressurized fluid provided in response to the second input from the valve control assembly when the first user input receives an input from a user.

According to another exemplary aspect of the present invention, a method of prioritizing inputs to a vehicle is provided. The method includes the steps of providing a vehicle including a chassis, a plurality of traction devices configured to propel the chassis on the ground, at least one hydraulic actuator, and a hydraulic control system. The hydraulic control system includes a pressure source, a first user input, a first control valve that receives input from the first user input to control the flow of fluid from the pressure source to the at least one hydraulic actuator, a second user input, and a second control valve that receives input from the first user input to control the flow of fluid from the pressure source to the at least one hydraulic actuator. The method further includes the step of diverting pressurized fluid from the second control valve in response to user input to the first user input.

Additional features of the present invention will become apparent to those skilled in the art upon consideration of the following detailed description of the presently perceived best mode of carrying out the invention.

### BRIEF DESCRIPTION OF THE DRAWINGS

The detailed description of the drawings particularly refers to the accompanying figures in which:

FIG. 1 is a side elevation view of a wheel loader showing the wheel loader including a chassis, a cab supported by the chassis, a bucket positioned in front of the chassis, and a plurality of wheels supporting the chassis on the ground; and

FIG. 2 is a schematic view of a hydraulic control system of the wheel loader for controlling the steering of the wheel loader.

### DETAILED DESCRIPTION OF THE DRAWINGS

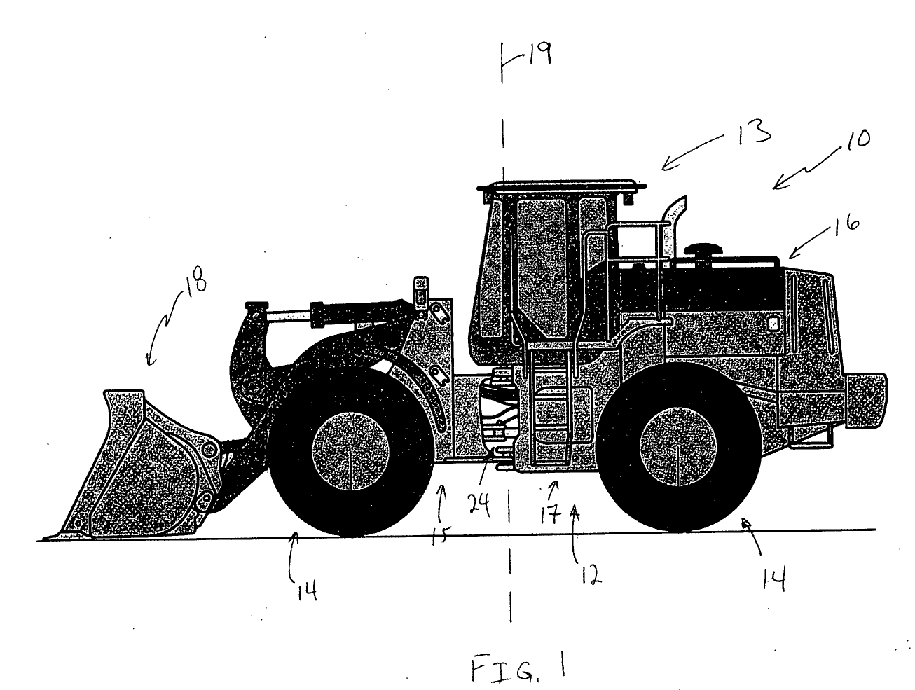

A wheel loader 10 is shown in FIG. 1 for moving bulk materials, such as dirt or rock, from one location to another. Loader 10 includes an articulated frame or chassis 12, a passenger cab 13, an plurality of wheels 14 to propel chassis 12 and the remainder of loader 10 along the ground, an engine 16 to power operation of loader 10, and a bucket 18 for scooping and dumping bulk material.

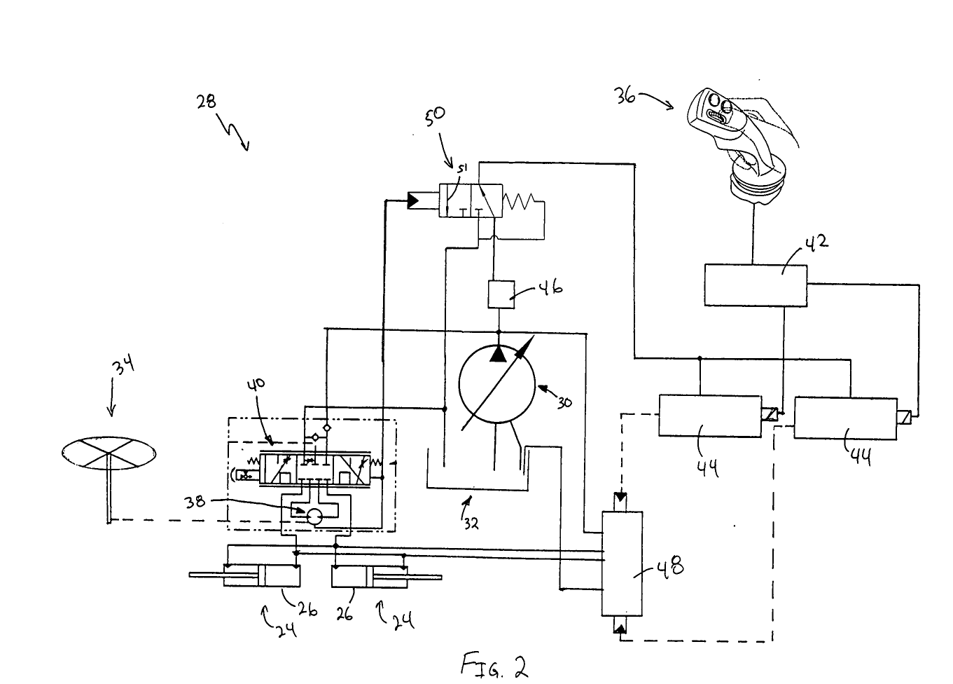

To move and power the various components of loader 10, it includes a plurality of hydraulic actuators 24. As shown in FIG. 2, such actuators 24 include steering cylinders 26 that control the direction of front wheels 14 relative to cab 13. Chassis 12 is articulated and includes a front portion 15 that pivots relative to a back portion 17 about a pivot axis 19. Hydraulic cylinders 26 extend between front and back portions 15, 17 on opposite sides of pivot axis 19 to control the relative positions of front and back portions 15, 17.

To power and control hydraulic actuators 24, loader 10 includes a hydraulic control system 28 as shown in FIG. 2. Hydraulic control system 28 includes a pressure source or hydraulic pump 30 that pressurizes the hydraulic fluid and a hydraulic fluid tank 32 that receives hydraulic fluid back from various components of control system 28. Additional details of a suitable hydraulic control system are provided in U.S. patent application Ser. No. 11/186,562, filed Jul. 21, 2005, to Harber et al., entitled “Load Sense Boost Device,” the entire disclosure of which is expressly incorporated by reference herein.

As shown in FIG. 2, loader 10 includes two operator inputs including steering wheel 34 and joystick 36 that control movement of steering cylinders 26. Steering wheel 34 and joystick 36 are positioned within cab 13. According to an exemplary embodiment of the present disclosure, control system 28 is configured to give steering wheel 34 priority over joystick 36 in the event both are providing input.

Steering wheel 34 is coupled to an orbital valve 38 that controls a first spool control valve 40. Depending on the direction and speed of rotation of steering wheel 34, orbital valve 38 controls the position of spool valve 40. The position of spool valve 40 controls the direction and rate of hydraulic fluid provided by pump 30 to steering cylinders 26 and the direction and rate of hydraulic fluid from steering cylinders 26 to tank 32. Spool valve 40 controls the flow of hydraulic fluid to and from steering cylinders 26 so they operate in opposite directions.

Joystick 36 is electronically coupled to an electronic controller 42 that receives input from joystick 36 and controls a plurality of solenoid valves 44. Solenoid valves 44 receive hydraulic fluid from pump 30. According to the exemplary embodiment of the present disclosure, a pressure reduction valve 46 reduces the pressure of the hydraulic fluid received from pump 30 and provided to solenoid valves 44.

Solenoid valves 44 provide pilot fluid to a second spool control valve 48 which controls the supply of hydraulic fluid to and from steering cylinders 26. Depending on the direction and extent of tilt of joystick 36, spool valve 48 controls the direction and rate of hydraulic fluid from pump 30 to steering cylinders 26 and the direction and rate of hydraulic fluid from steering cylinders 26 to tank 32. Spool valve 48 controls the flow of hydraulic fluid to and from steering cylinders 26 so they operate in opposite directions.

As mentioned above, control system 28 is configured to give input to steering wheel 34 priority over input to joystick 36. A priority valve 50 is provided between pressure reduction valve 46 that provides priority to steering wheel 34 over joystick 36. As steering wheel 34 turns, orbital valve 38 provides an output pressure signal to spool valve 40 which also provides pilot pressure to priority valve 50. Thus, when steering valve 40 rotates, orbital valve 38 controls the position of priority valve 50.

As shown in FIG. 2, steering wheel 34 is stationary so that no pilot pressure from orbital valve 38 is supplied to priority valve 50. When in this position, priority valve 50 provides pilot pressure to solenoid valves 44 and joystick 36 is enabled to steer loader 10. When steering wheel 34 rotates, pilot pressure is provided to priority valve 50 and it shifts to the left from the position shown in FIG. 2. When in this position, priority valve 50 blocks pilot pressure to solenoid valves 44 and diverts or dumps any pilot pressure to solenoid valves 44 to tank 32. Thus, a passage 51 in priority valve 50 provides a diverter. Additionally, any pilot pressure between solenoid valves 44 and spool valve 48 may also be diverted to tank 32. Without any pilot pressure, spool valve 48 remains in a neutral position and does not influence the operation of steering cylinders 26. When steering wheel 34 is again stationary, priority valve 50 shifts back to the position shown in FIG. 2 and pilot pressure is again provided to solenoid valves 44 so that joystick 36 may again control steering cylinders 26. Together, first and second control valves 40, 48 cooperate to define valve control assembly. In an alternative embodiment, the valve control assembly includes a single valve that receives multiple inputs.

According to an alternative embodiment of the present disclosure, a valve (not shown) is provided between pressure reducing valve 46 and pump 30 to block the flow of fluid when an input is detected to steering wheel 34. Such a valve may be piloted in a manner similar to priority valve 50. Thus, when steering wheel 34 is rotated, pilot fluid is blocked from solenoids 44 to block input from joystick 36. Alternatively, this valve may also be provided between pressure reducing valve 46 and solenoids 44. In these embodiments, priority valve 50 may or may not be provided.

The control system above has been described in reference to a wheel loader. According to other embodiments of the present disclosure, the control system may be provided on other vehicles such as articulated dump trucks, backhoe loaders, dozers, crawler loaders, excavators, skid steers, scrapers, trucks, cranes, graders, or any other type of vehicles known to those of ordinary skill in the art. In addition to wheels, other types of traction devices may be provided on such vehicles such as tracks or other traction devices known to those of ordinary skill in the art.

According to alternative embodiments of the present disclosure, the priority of other inputs are control by the priority system described above. For example, other dual inputs functions may be provided with a priority system, such as dual bucket controls on a wheel loader, backhoe, or other vehicle having multiple bucket controls; dual boom controls on a backhoe or other vehicle having a boom with multiple boom control inputs; and any other vehicle functions having dual inputs for the particular function. Additionally, the priority system described above may be used on controls for different functions where is it is desirable to give one function priority over another function.

Although the invention has been described in detail with reference to certain preferred embodiments, variations and modifications exist within the spirit and scope of the invention as described and defined in the following claims.

1. A vehicle including
a chassis,
a plurality of traction devices configured to propel the chassis on the ground,
at least one hydraulic actuator positioned to power a function of the vehicle, and
a hydraulic control system including
a pressure source providing pressurized hydraulic fluid,
a first user input,
a valve control assembly that receives pressurized fluid in response to the first user input to control the flow of fluid from the pressure source to the at least one hydraulic actuator,
a second user input, the valve control assembly receiving pressurized fluid in response to the second user input to control the flow of fluid from the pressure source to the at least one hydraulic actuator, and
a diverter that communicates the pressurized fluid provided in response to the second input from the valve control assembly when the first user input receives an input from a user.

2. A method of prioritizing inputs to a vehicle including the steps of
providing a vehicle including
a chassis,
a plurality of traction devices configured to propel the chassis on the ground,
at least one hydraulic actuator, and
a hydraulic control system including
a pressure source,
a first user input,
a first control valve that receives input from the first user input to control the flow of fluid from the pressure source to the at least one hydraulic actuator,
a second user input, and
a second control valve that receives input from the first user input to control the flow of fluid from the pressure source to the at least one hydraulic actuator, and
diverting pressurized fluid from the second control valve in response to input to the first user input.
